(19) United States
(12) Patent Application Publication
(10) Pub. No.: US 2024/0369692 A1
(43) Pub. Date: Nov. 7, 2024

(54) DIAGNOSTIC METHOD FOR POSITION AND ORIENTATION OF LIDAR, LIDAR AND AUTONOMOUS DRIVING VEHICLE

(71) Applicant: HESAI TECHNOLOGY CO., LTD., Shanghai (CN)

(72) Inventors: Qingguo YU, Shanghai (CN); Xin ZHAO, Shanghai (CN); Shaoqing XIANG, Shanghai (CN)

(73) Assignee: HESAI TECHNOLOGY CO., LTD., Shanghai (CN)

(21) Appl. No.: 18/759,508

(22) Filed: Jun. 28, 2024

Related U.S. Application Data
(63) Continuation of application No. PCT/CN2022/099092, filed on Jun. 16, 2022.

(30) Foreign Application Priority Data
Dec. 30, 2021 (CN) 202111654107.4

(51) Int. Cl. G01S 7/497; G01S 7/48; G01S 17/86; G01S 17/931

(52) U.S. Cl. CPC G01S 7/4972; G01S 7/4808; G01S 17/86; G01S 17/931

(57) ABSTRACT

This disclosure provides a diagnostic method for a position and orientation of a LiDAR, where the LiDAR is fixed to an apparatus, the diagnostic method including: determining a first reference data of scanning a calibration object by the LiDAR when it is in a standard position and orientation; controlling the LiDAR to scan the calibration object in a current position and orientation and collect a first measurement data of the LiDAR; and determining, based on the first reference data and the first measurement data, whether the current position and orientation of the LiDAR deviates from the standard position and orientation. In embodiments of this disclosure, using the characteristics of point cloud data of the LiDAR, the LiDAR diagnoses by itself an abnormal change in its relative position and orientation to the apparatus during the normal operation without the cooperation of other detector devices. Calculations of the diagnostic method are simple, and results are accurate. Embodiments of this disclosure further provide a LiDAR and an autonomous driving vehicle. By using the aforementioned diagnostic method, the relative position and orientation of the LiDAR to the autonomous driving vehicle can be quickly and accurately diagnosed, which can ensure safe operation of the autonomous driving vehicle.

### TECHNICAL FIELD

This disclosure generally relates to the technical field of light detection and ranging (“LiDAR”), and, in particular, to a diagnostic method for a position and orientation of a LiDAR, a LiDAR, an autonomous driving vehicle, and a computer-readable storage medium.

### BACKGROUND

LiDAR is a commonly used detector device that uses a reflected echo from a target to determine information about the target. It is widely used in the fields of autonomous driving, environment monitoring, traffic communication, and measurement and mapping, or the like. Because parameters such as a distance, orientation, height and velocity of the target are relative parameters determined relative to a mounting position of the LiDAR, the LiDAR has strict requirements for the accuracy of the mounting position. LiDAR can be typically fixed to an apparatus by means of a mechanical connection. After determining a raw point cloud data of the LiDAR, the apparatus can determine a transformation matrix between the LiDAR coordinate system and the world coordinate system based on a relative position and orientation information between the LiDAR and the apparatus. The transformation matrix can be used to convert the raw point cloud data of the LiDAR into environmental three-dimensional data relative to the apparatus. However, in the actual using process, due to collision or scraping, or the like, abnormal change of the relative position between the LiDAR and the apparatus may occur. The three-dimensional data determined by the apparatus through calculation can be abnormal, which can lead to an abnormality in the precision of the surveying and mapping, which can easily lead to safety accidents.

In existing techniques, the relative position and orientation between the LiDAR and the apparatus needs to be diagnosed in cooperation with other detector apparatuses. When the LiDAR detects the surrounding environment, a camera mounted on the apparatus can be utilized to capture an image of the surrounding environment. The point cloud data of the LiDAR can be compared with the image obtained by the camera to determine whether the relative position and orientation between the LiDAR and the apparatus has changed. However, the method requires the point cloud data of the LiDAR to be matched with the image, and other detector apparatuses for diagnosing the position and orientation of the LiDAR need to be mounted on the apparatus. in the method is not only a cumbersome process, but can also increase the structure complexity of the apparatus.

The content of the background is merely the technology known to the inventor and do not necessarily represent the existing techniques in the field.

### SUMMARY

With respect to one or more disadvantages in the existing techniques, this disclosure provides a diagnostic method for a position and orientation of a LiDAR. The LiDAR can diagnose automatically an abnormal change in a relative position and orientation to an apparatus during normal operation without a cooperation of other detector devices. The diagnostic process can be simple and rapid, and a diagnostic result can be accurate. This disclosure further provides a LiDAR and an autonomous driving vehicle mounted with the LiDAR. By using the aforementioned diagnostic method, the relative position and orientation between the LiDAR and the autonomous driving vehicle can be diagnosed quickly. Abnormal changes in the position and orientation of the LiDAR can be prevented. Safe operation of the autonomous driving vehicle can be ensured. This disclosure further provides a computer-readable storage medium for performing the aforementioned diagnostic method.

To solve the above technical problems, this disclosure uses the following technical solutions:
A diagnostic method for a position and orientation of a LiDAR, where the LiDAR can be fixed to an apparatus, the diagnostic method including: determining first reference data of scanning a calibration object by the LiDAR when it is in a standard position and orientation; controlling the LiDAR to scan the calibration object in a current position and orientation and collect first measurement data of the LiDAR; and determining, based on the first reference data and the first measurement data, whether the current position and orientation of the LiDAR deviates from the standard position and orientation.

Based on an aspect of this disclosure, determining, based on the first reference data and the first measurement data, whether the current position and orientation of the LiDAR deviates from the standard position and orientation includes: comparing the first reference data and the first measurement data, and determining that the current position and orientation of the LiDAR deviates from the standard position and orientation when a difference between the first reference data and the first measurement data is greater than a predetermined threshold.

Based on an aspect of this disclosure, the calibration object can be a reference plane, the first reference data including a reference point cloud determined by scanning the reference plane by the LiDAR when it is in the standard position and orientation, and the first measurement data including a measurement point cloud determined by scanning the reference plane by the LiDAR when it is in the current position and orientation.

Based on an aspect of this disclosure, a parameter includes one or more of: a shape of a point cloud; a number of point cloud rings; a spacing between point cloud rings; a radius of a point cloud ring; or a distance corresponding to a data point in the point cloud.

Based on an aspect of this disclosure, the diagnostic method further includes: determining, based on the first measurement data, whether the apparatus is on a plane parallel to the reference plane, and performing the step S103 when the apparatus is on the plane parallel to the reference plane.

Based on an aspect of this disclosure, the calibration object includes a preset structure on the apparatus located within a scanning range of the LiDAR, the first reference data including at least one of a distance or an orientation determined by scanning the preset structure by the LiDAR when it is in the standard position and orientation, and the first measurement data including at least one of a distance or an orientation determined by scanning the preset structure by the LiDAR when it is in the current position and orientation.

Based on an aspect of this disclosure, the preset structure includes a fixed structure or another LiDAR on the apparatus.

Based on an aspect of this disclosure, the position and orientation includes at least one of a mounting height or a mounting angle.

Based on an aspect of this disclosure, determining, based on the first reference data and the first measurement data, whether the current position and orientation of the LiDAR deviates from the standard position and orientation further includes: determining, when the current position and orientation of the LiDAR deviates from the standard position and orientation, deviation direction of the current position and orientation relative to the standard position and orientation.

Based on an aspect of this disclosure, determining the first reference data of scanning a calibration object by the LiDAR when it is in the standard position and orientation includes: arranging the LiDAR in the standard position and orientation; controlling the LiDAR to scan the calibration object and determine a measurement value of the LiDAR; and storing the measurement value as the first reference data.

Based on an aspect of this disclosure, determining the first reference data of scanning a calibration object by the LiDAR when it is in the standard position and orientation further includes: determining whether the measurement value is reasonable, and controlling the LiDAR to scan the calibration object and determine the measurement value of the LiDAR when the measurement value is not reasonable.

Based on an aspect of this disclosure, determining, based on the first reference data and the first measurement data, whether the current position and orientation of the LiDAR deviates from the standard position and orientation further includes: incrementing a number of consecutive failures and performing step S1033 when determining that the current position and orientation of the LiDAR deviates from the standard position and orientation; clearing the number of consecutive failures to zero when determining that the current position and orientation of the LiDAR does not deviate from the standard position and orientation; and determining whether the number of consecutive failures reaches a number threshold, and sending diagnostic information when the number of consecutive failures reaches the number threshold.

Based on an aspect of this disclosure, multiple LiDAR can be arranged at different positions on the apparatus, the diagnostic method further including: confirming whether a position and orientation of the apparatus deviates from a calibration position and orientation when the multiple LiDAR deviate from standard position and orientations, the calibration position and orientation being a position and orientation of the apparatus when determining the first reference data of scanning a calibration object by the LiDAR when it is in the standard position and orientation.

Based on an aspect of this disclosure, the LiDAR includes multiple detection channels, part of the multiple detection channels can be used to perform the diagnostic method.

A LIDAR, including: an emitter apparatus configured to emit a detection signal to a surrounding environment; a detector apparatus configured to receive an echo of the detection signal; and a processor apparatus configured to generate a point cloud of the LiDAR based on the echo and configured to perform the diagnostic method as previously described.

An autonomous driving vehicle, including: one or more LiDAR fixed to the autonomous driving vehicle; and a radar detection system in communication with the LiDAR and configured to perform the diagnostic method as previously described.

Based on an aspect of this disclosure, the autonomous driving vehicle further includes a vehicle detection system in communication with the radar detection system and configured to detect a position and orientation of the autonomous driving vehicle.

A computer-readable storage medium including a computer-executable command stored on the computer-readable storage medium, where the executable command can perform the diagnostic method as previously described when executed by a processor.

Compared with the existing techniques, embodiments of this disclosure provide a diagnostic method for the position and orientation of a LiDAR. Using the characteristics of the point cloud data of the LiDAR, the LiDAR can diagnose independently an abnormal change in its relative position and orientation to the apparatus during normal operation. The diagnostic method does not need the cooperation of other detector devices. The calculations can be simple and the results can be accurate. Embodiments of this disclosure further provide a LiDAR and an autonomous driving vehicle. By applying the aforementioned diagnostic method, the relative position and orientation between the LiDAR with the autonomous driving vehicle can be diagnosed quickly and accurately. Safe operation of the autonomous driving vehicle can be ensured. This disclosure further provides a computer-readable storage medium for performing the aforementioned diagnostic method.

### BRIEF DESCRIPTION OF DRAWINGS

Drawings are used to provide further understanding of this disclosure, form an integral part of the specification, are used to interpret this disclosure together with the embodiments of this disclosure, and do not imposition and orientation any limitation on this disclosure. In the drawings:

FIG. 1 shows a schematic flowchart of an example diagnostic method for a position and orientation of a LiDAR, consistent with some embodiments of this disclosure.

FIG. 2 shows a schematic flowchart of an example diagnosis of a position and orientation of the LiDAR based on a point cloud, consistent with some embodiments of this disclosure.

FIG. 3A shows an example point cloud of a 360° mechanically rotating LiDAR on a reference plane when it is in a standard position and orientation, consistent with some embodiments of this disclosure.

FIG. 3B shows an example point cloud of a hybrid solid-state LiDAR on a reference plane when it is in a standard position and orientation, consistent with some embodiments of this disclosure.

FIG. 4 shows an example comparison diagram of a LiDAR before and after an abnormal change in a mounting height direction, consistent with some embodiments of this disclosure.

FIG. 5 shows an example comparison diagram of a LiDAR before and after an abnormal change in a mounting angle direction, consistent with some embodiments of this disclosure.

FIG. 6 shows a schematic diagram of an example positional relationship between a LiDAR and a preset structure, consistent with some embodiments of this disclosure.

FIG. 7 shows a schematic flowchart of an example method for determining a reference data by a LiDAR, consistent with some embodiments of this disclosure.

FIG. 8 shows a schematic flowchart of an example misdiagnosis elimination process included in a diagnostic method for a position and orientation of a LiDAR, consistent with some embodiments of this disclosure.

FIG. 9 shows a schematic diagram of an example LiDAR, consistent with some embodiments of this disclosure.

FIG. 10 shows a structural block diagram of an example autonomous driving vehicle with a LiDAR, consistent with some embodiments of this disclosure.

### DETAILED DESCRIPTION

Some illustrative embodiments are described below. As would be understood by those skilled in the art, the described embodiments may be modified in numerous ways without departing from the spirit or scope of this disclosure. Accordingly, the accompanying drawings and description are considered to be essentially exemplary and non-limiting.

In the description of this disclosure, it should be understood that orientation or position relationships represented by terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “anticlockwise,” or the like, are orientation or position relationships shown based on the accompanying drawings, are used not to indicate or imply that indicated apparatuses or elements must be in specific orientations or be structured and operated in specific orientations but only to conveniently describe this disclosure and simplify the description, and thus should not be understood as limits to this disclosure. In addition, the terms “first” and “second” are used for the purpose of description only and cannot be understood as indicating or implying relative importance or implicitly indicating the number of technical features indicated. Thus, features defined with “first” or “second” may explicitly or implicitly include one or more of the features. In the description of this disclosure, “plurality” refers to two or more than two, unless otherwise explicitly and specifically defined.

In the description of this disclosure, it should be noted that, unless otherwise specifically stipulated and defined, the terms “installation,” “connected,” and “connection” should be understood in a broad sense, for example, may be a fixed connection, or may be a detachable connection or an integrated connection; may be a mechanical connection, or may be an electrical connection, or may be mutual communication; may be a direct connection, or may be an indirect connection through an intermediate medium, or may be an internal communication between two elements or an interaction relationship between two elements. For those of ordinary skills in the art, the specific meanings of the above terms in this disclosure may be understood based on specific circumstances.

In this disclosure, unless otherwise explicitly stipulated and defined, the first feature “above” or “below” the second feature may include the first feature in direct contact with the second feature, or may include the first feature not being in direct contact with the second feature, but in contact with the second feature through other features between them. Further, the first feature being “over,” “above,” and “on” the second feature includes the first feature being over or above the second feature, or merely represents that the horizontal height of the first feature is higher than that of the second feature. The first feature being “under,” “below,” and “underneath” the second feature represents the first feature being over and above the second feature, or merely indicates that the horizontal height of the first feature is lower than that of the second feature.

The following disclosure provides many different embodiments or examples for implementing different structures of this disclosure. To simplify this disclosure, components and arrangements of particular examples are described below. Of course, they are merely examples, and are not intended to limit this disclosure. Further, in this disclosure, reference numbers and/or reference letters may be repeated in different examples. Such repetition is for purposes of simplicity and clarity, and itself does not indicate a relationship between the discussed embodiments and/or arrangements. In addition, this disclosure provides examples of various particular processes and materials, but those of ordinary skills in the art can appreciate the application of other processes and/or the use of other materials.

The optional embodiments of this disclosure are described below with reference to the drawings. It should be understood that the optional embodiments described here are used to illustrate and interpret this disclosure, and are not intended to limit this disclosure.

The LiDAR can typically be fixed to an apparatus. The LiDAR can be a mechanically rotating radar, a hybrid solid-state radar, or a solid-state LiDAR. The apparatus can be an autonomous driving vehicle, an unmanned aerial vehicle, or a measurement and mapping instrument, or the like. An emitter apparatus and a detector apparatus in the mechanically rotating radar can be arranged on a rotor and can rotate with the rotor about a fixed axis to achieve a greater scanning range. For example, the mechanically rotating radar can perform a 360° rotational scanning in a horizontal plane. An emitter apparatus and a detector apparatus in the hybrid solid-state LiDAR do not rotate themselves. A detection light emitted from the emitter apparatus can be deflected by a scanner mirror such as a rotary mirror or an oscillating mirror to a target space, and the detection light can be deflected to different angles by a rotation of the scanner mirror. A detection range of the hybrid solid-state LiDAR in the horizontal plane is a sector shaped region and a horizontal field of view angle is typically less than 180°. In the solid-state LiDAR, there are no mechanical rotating components. By means of a design of a light-emitter element, a detector element and a corresponding optical element, a detection light can cover a certain horizontal and vertical field of view.

In the LiDAR, some of the lasers can emit laser beams at positive angles with respect to a bottom plane (with a vertical angle of 0°) of the LiDAR, and some of the lasers emit laser beams at negative angles with respect to that bottom plane, which can form a vertical field of view of the LiDAR. For example, for a horizontally mounted LiDAR, a laser beam emitted at a negative angle can hit the ground disregarding the effects of the light-emitting power and ground conditions on a laser echo, and assuming no other objects obstruct the laser beam.

Based an embodiment of this disclosure, a position and orientation of the LiDAR includes at least one of a mounting height or a mounting angle relative to the apparatus. Taking an autonomous driving vehicle as an example, the LiDAR can typically be mounted at at least one of a fixed mounting height or mounting angle on a roof or at other positions of the autonomous driving vehicle.

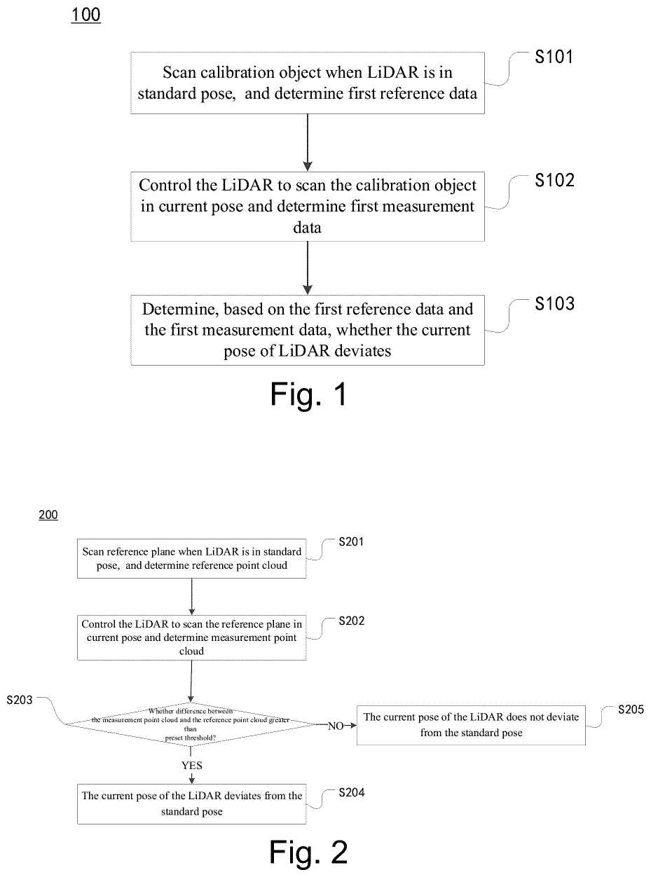

FIG. 1 shows an example diagnostic method 100 for the position and orientation of the LiDAR, consistent with some embodiments of this disclosure.

In step S101, a first reference data of scanning a calibration object by the LiDAR when it is in a standard position and orientation is determined, where the standard position and orientation of the LiDAR refers to the position and orientation of the LiDAR relative to the apparatus after calibration detection. And after a transformation of a raw point cloud data of the LiDAR, an accurate relative positional relationship between the apparatus and the scanning target can be determined.

The calibration of the LiDAR can be performed in a fixed location and various preset planes or structures can be used as a scanning calibration object. Based on an optional embodiment of this disclosure, the calibration object in this step can be at least one of a reference plane or a preset structure on the apparatus located within the scanning range of the LiDAR. The reference plane can be a specific plane within a calibration workshop or other planes with a fixed position relative to the apparatus, for example, a horizontal and even ground, a sloping surface with a specific angle, or the like. A fixed preset structure on the apparatus can also be used as the scanning calibration object. The preset structure can be a protrusion with a particular shape, other LiDAR or detector device, or the like. The preset structure is located within the detection range of the LiDAR.

When calibrating the LiDAR, first confirm that the LiDAR is in a standard position and orientation, at which time the calibration object can be scanned and the first reference data can be determined. The first reference data can be an echo data or a point cloud determined by the LiDAR, or a feature value extracted from the echo data and the point cloud, or the like. The example data and types of the first reference data are described in detail in subsequent embodiments.

In step S102, the LiDAR can be controlled to scan the calibration object in a current position and orientation and collect a first measurement data of the LiDAR.

The calibration object in step 102 corresponds to the calibration object in step S101. For example, using the reference plane as the calibration object, the reference plane scanned in steps S101 and S102 correspond to the same plane. For example, the calibration object in steps S101 and S102 are both a specific plane within the same calibration workshop, or may be a plane having the same features. For example, the reference plane in step S101 is a horizontal and even ground, and a horizontal and even plane (e.g., a road surface) at any position may be selected as the calibration object in this step. The types of the first measurement data and the first reference data correspond to each other. For example, the shape of the point cloud of LiDAR or the feature values extracted from the echo data and the point cloud can be selected.

In step S103, based on the first reference data and the first measurement data, it is determined whether the current position and orientation of the LiDAR deviates from the standard position and orientation.

After the LiDAR scans the calibration object and receives an echo, its echo data and the generated point cloud have corresponding shapes. When the LiDAR scans the same calibration objects in the current position and orientation and determines data of the same type, it can be determined whether the current position and orientation of the LiDAR deviates from the standard position and orientation. And a deviation direction of the LiDAR can be determined based on the deviation between the first measurement data and the first reference data. For example, the first reference data in step S101 is determined based on scanning the calibration object by the LiDAR when it is in the standard position and orientation, and the first measurement data of the LiDAR in step S102 is also determined based on scanning the same calibration object. In such a case, the first measurement data can be sufficiently correlate with or correspond to the first reference data when the current position and orientation of the LiDAR does not deviate from the standard position and orientation, which is be described in detail in other embodiments.

As shown in FIG. 2, consistent with an optional embodiment of this disclosure, in the diagnostic method 200 for the position and orientation of a LiDAR, the calibration object is a reference plane, for example, a horizontal plane. In step S201, the LiDAR can scan the reference plane and determine a reference point cloud when it is in a standard position and orientation. The point cloud can be generated by all laser beams emitted in the LiDAR at negative angles to the reference plane being reflected by the reference plane and received by the LiDAR, or it may be generated by laser beams from part of the channels being reflected by the reference plane and received by the LiDAR.

Based on an optional embodiment of this disclosure, the first reference data and first measurement data can include one or more of a shape of a point cloud, a number of point cloud rings, a spacing between point cloud rings, a radius of a point cloud ring, or a distance corresponding to a data point in the point cloud.

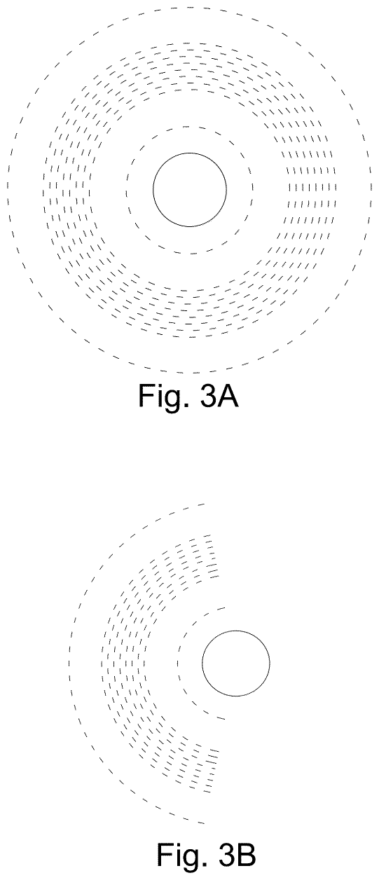

Taking the horizontal plane as an example, the standard position and orientation can be the position and orientation of the LiDAR when it is placed horizontally, for example, the plane with a vertical angle of 0° of the LiDAR is parallel to the reference plane. As shown in FIG. 3A, the point cloud determined by the 360° mechanically rotating LiDAR in the standard position and orientation when scanning the horizontal plane is shaped as multiple concentric circles in which the point cloud rings are concentric circles. For example, the number of concentric circles can be the number of point cloud rings, which represents the number of laser beams in the LiDAR at negative angles with respect to the horizontal plane. The spacing between the concentric circles can be the spacing between the point cloud rings. The radii of the concentric circles can be the radii of the point cloud rings. And each of the concentric circles contains multiple data points, and each of the data points contains corresponding distance information.

As shown in FIG. 3B, the emitter apparatus and the detector apparatus in the hybrid solid-state radar and the solid-state LiDAR are not rotatable. In such a case, the point cloud determined by scanning the horizontal plane is multiple concentric circular arcs with the same circumferential angle. In this case, the point cloud rings are arcs. For example, the number of concentric circular arcs can be the number of point cloud rings, which represents the number of laser beams in the LiDAR at negative angles with respect to the horizontal plane. The spacing between the concentric circular arcs can be the spacing between the point cloud rings. The radii corresponding to the concentric circular arcs can be the radii of the point cloud rings. And each of the concentric circular arcs contains multiple data points, and each of the data points includes corresponding distance information.

The spacing between the point cloud rings can be the spacing between any two point cloud rings. The radius of a point cloud ring can be the radius of any point cloud ring. And the data point in the point cloud can be a data point on any point cloud ring.

As can be seen, for whichever kind of LiDAR, the point cloud with respect to a reference plane at a fixed position has a specific shape and feature values. When the LiDAR is in the standard position and orientation, the shape, the number, the spacing, the dimensions, and the corresponding distances of the concentric circles or concentric circular arcs in the point cloud determined from scanning of the horizontal plane by the LiDAR can all be specific values.

In step S202, the LiDAR can scan the reference plane in a current position and orientation and determine a measurement point cloud. The point cloud determined by the LiDAR of scanning the reference plane also has a certain shape and corresponding feature values. In step S203, it is determined whether a difference between a parameter of the reference point cloud and a parameter of the measurement point cloud (the parameter can be one or more of a shape of a point cloud, a number of point cloud rings, a spacing between point cloud rings, a radius of a point cloud ring, or a distance corresponding to a data point in the point cloud) is greater than a predetermined threshold. When the difference between the parameter of the reference point cloud and the parameter of the measurement point cloud is greater than the preset threshold, it is determined in step S204 that the current position and orientation of the LiDAR deviates from the standard position and orientation. When the difference between the parameter of the reference point cloud and the parameter of the measurement point cloud is not greater than the preset threshold, it is determined in step S205 that the current position and orientation of the LiDAR does not deviate from the standard position and orientation.

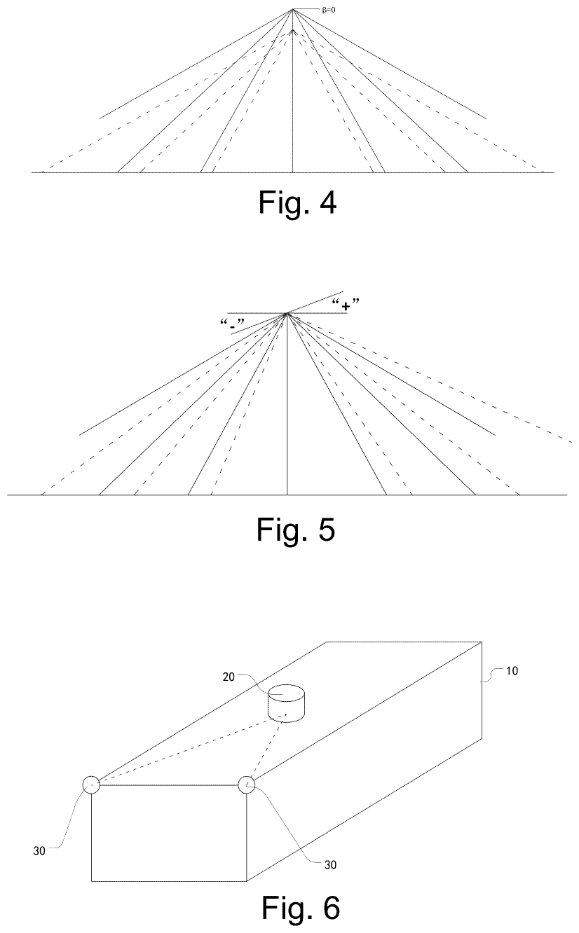

As described in the prior embodiments, the position and orientation of the LiDAR can include at least one of a mounting height or a mounting angle. The following illustrates, with reference to FIGS. 4 and 5, the changes in the point cloud when the LiDAR deviates in the mounting height direction or in the mounting angle direction.

As shown in FIG. 4, the solid lines are the schematic illustrations of the optical paths of some laser beams at negative angles to the horizontal plane when the LiDAR is in the standard position and orientation. The dashed lines are the schematic illustrations of the optical paths when the LiDAR deviates in the mounting height direction. B represents the mounting angle, which can be represented by the angle between the bottom plane of the LiDAR and the bottom plane of the LiDAR when it is in the standard position and orientation. The mounting angle of the case shown in FIG. 4 is 0, for example, there is no deviation in the mounting angle of the LiDAR. When the LiDAR deviates from the standard position and orientation in the vertical direction, the angular orientation of the LiDAR does not change. In such a case, the shape of the point cloud does not change and remains as multiple concentric circles or circular arcs, but both the spacing between and dimensions of the concentric circles or circular arcs change. As shown in FIG. 4, the mounting height of the LiDAR is decreased in the current position and orientation compared to that in the standard position and orientation. In such a case, the number of point cloud rings in the measurement point cloud remains unchanged, while the spacing between the point cloud rings is decreased, the radius of each point cloud ring is decreased, and the distances corresponding to data points on the point cloud ring are decreased. Accordingly, when the mounting height of the LiDAR is increased in the current position and orientation compared to that in the standard position and orientation, the number of point cloud rings in the measurement point cloud can remain unchanged, while the spacing between the point cloud rings, the radius of a point cloud ring, and the distances corresponding to data points in the point cloud can change oppositely. After comparing the measurement point cloud with the reference point cloud, when a change as described above occurs, it can be determined that the current position and orientation of the LiDAR deviates from the standard position and orientation in the mounting height direction. Furthermore, based on the direction of the numerical change and the difference in magnitude, a direction of deviation and a distance of deviation of the current position and orientation relative to the standard position and orientation can be determined.

As previously described, when the LiDAR is in the standard position and orientation, the point cloud with respect to the horizontal plane can be multiple concentric circles or concentric circular arcs, the center of which can be the projection of the LiDAR in the horizontal plane. As shown in FIG. 5, when the current position and orientation of the LiDAR deviates in the mounting angle with respect to the standard position and orientation, for example, β≠0, the bottom plane of the LiDAR moves closer relative to the horizontal plane on one side (the left side in FIG. 5, indicated by “−” in the figure), and the bottom plane moves away from the horizontal plane on the other side (the right side in FIG. 5, represented by “+” in the figure). The point cloud changes to multiple ellipses or elliptical arcs, for example, the shape of the point cloud changes. The point cloud rings are ellipses or elliptical arcs. The spacing between the point cloud rings and the distances corresponding to data points on the point cloud rings decrease on the “−” side and increase on the “+” side. The radius of the point cloud ring is the distance between the projection of the LiDAR in the horizontal plane and the vertex of the elliptical arc. In such a case, the radius of the point cloud ring reduces on the “−” side and increases on the “+” side. The spacing between the point cloud rings and the distances corresponding to the data points also change, decreasing on the “−” side and increasing on the “+” side. The larger the deviation angle of the LiDAR, the more significant the change in the shape and the feature values of the point cloud. And it can also be determined that the deviation direction of the mounting angle of the LiDAR is tilted toward the side of the ellipses or the elliptical arcs between which the spacing is reduced. When the deviation angle exceeds the vertical angular resolution of the LiDAR, the number of point cloud rings changes. For example, the number of point cloud rings increases on the “−” side and reduces on the “+” side.

The above illustrates the deviation in two special cases, and in the actual using process, the LiDAR can simultaneously include the deviates of the above two cases, for example, both the mounting height and the mounting angle can change. In such a case, the change of the point cloud can be a combination of the two point cloud changes. In another embodiment of this disclosure, the direction of deviation of the current position and orientation of the LiDAR relative to the standard position and orientation can be determined based on the change of the point cloud with reference to the aforementioned change rule.

Based on an embodiment of this disclosure, predetermined thresholds can be different for different parameters (e.g., one or more of a shape of a point cloud, a number of point cloud rings, a spacing between the point cloud rings, a radius of a point cloud ring, or a distance corresponding to a data point in the point cloud). For example, a predetermined threshold of the number of point cloud rings can be 1. A predetermined threshold of the spacing between point cloud rings or the ring radius can be 2 cm or 5 cm or other values.

The predetermined thresholds of different point cloud rings can be different. For example, the ring spacing, the ring radius, and the distance corresponding to the data points of a point cloud ring for example closer to the center are smaller, and the predetermined threshold can be smaller. The ring spacing, the ring radius, and the distance corresponding to the data points of a point cloud ring for example relatively far from the center are larger, and the predetermined threshold can be larger. In an embodiment, as the distance of the point cloud ring from the center increases, the predetermined threshold corresponding to one or more of the spacing between the point cloud ring, the radius of the point cloud ring, and the distance corresponding to the data points in the point cloud increase in sequence.

As shown in FIGS. 4 and 5, even when the LiDAR deviates from the standard position and orientation, the point cloud determined by scanning the reference plane matches to a specific shape and specific data. In such a case, based on an optional embodiment of this disclosure, when the calibration object is a reference plane (e.g., a horizontal plane), it is determined whether the apparatus is on a plane parallel to the reference plane based on the first measurement data. When the apparatus is on the plane parallel to the reference plane, the diagnosis continues. When the first measurement data does not match the point cloud feature in the case where the apparatus is parallel to the reference plane, the current position of the apparatus is determined not on a horizontal plane, and the first measurement data is not valuable for comparison with the first reference data.

In some scenarios, there may be potholes, obstacles, or the like on the road surface. In such a case, the point cloud determined by the LiDAR scanning the road surface does not match the shape of the point cloud of scanning a horizontal plane, and the distance and orientation information of the obstacles can be determined based on the point cloud. In such a case, whether the road surface scanned by the LiDAR is the plane parallel to the reference plane can be determined based on the first measurement data. When the road surface scanned by the LiDAR is the plane parallel to the reference plane, for example, when the apparatus is on the plane parallel to the reference plane, the diagnosis of the position and orientation of the LiDAR continues. As a result, diagnostic errors caused by deviation in the scanned surface can be reduced, which can improve the accuracy of the diagnostic results.

Based on an optional embodiment of this disclosure, the calibration object further includes a preset structure on the apparatus located within the scanning range of the LiDAR. For example, as shown in FIG. 6, two preset structures 30 are fixed to the apparatus 10. The preset structures 30 can be fixed structures, and further, can be special shapes that easy to be scanned and recognized by the LiDAR 20. The calibration object can be other detection structures, for example, another LiDAR. The first reference data includes at least one of a distance or an orientation determined by scanning the preset structure 30 by the LiDAR 20 when it is in the standard position and orientation. Accordingly, the first measurement data includes at least one of a distance or an orientation determined by scanning the preset structure 30 by the LiDAR 20 when it is in the current position and orientation.

After the LiDAR 20 has been calibrated, its relative position to the apparatus 10 can be fixed. Further, the relative position of the LiDAR 20 to the preset structure 30 on the apparatus 10 can also be fixed. The relative position here includes at least one of a distance or an azimuth angle. When the LiDAR 20 deviates relative to the apparatus 10, its relative position to the preset structure 30 can also change, which can be used to diagnose whether the current position and orientation of the LiDAR 20 deviates. Further, as shown in FIG. 6, multiple preset structures 30 can be arranged at different positions on the apparatus 10. When at least one of the distances or orientations determined by scanning the multiple preset structures 30 by the LiDAR 20 deviates from the first reference data, it is determined that the current position and orientation of the LiDAR 20 deviates from the standard position and orientation, which can improve the accuracy of the diagnosis.

Based on an optional embodiment of this disclosure, the deviation direction and the deviation value of the LiDAR 20 can be determined based on the deviation direction and the deviation value of at least one of the distance or angle of the LiDAR 20 from the preset structure 30.

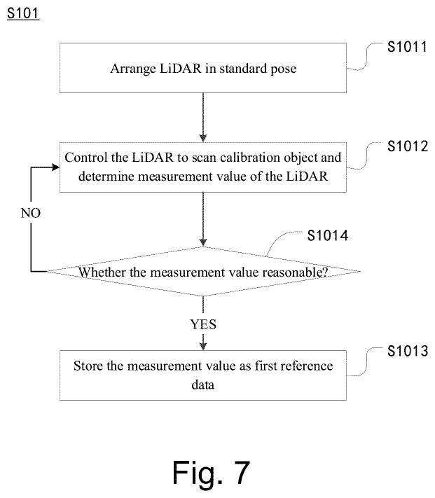

FIG. 7 shows a detailed flow of an example method S101 for determining reference data by a LiDAR, consistent with an optional embodiment of this disclosure, which is described in detail below in connection with FIG. 7.

In step S1011, the LiDAR can be arranged in the standard position and orientation. The standard position and orientation in this step includes at least one of a mounting height or a mounting angle of the LiDAR. The LiDAR can be fixed to the apparatus within a calibration workshop. The relative positions between the LiDAR and the apparatus can be calibrated, the calibration being based on the standard position and orientation.

In step S1012, the LiDAR can be controlled to scan the calibration object and determined a measurement value of the LiDAR. As previously described, the calibration object in this step can be a reference plane or a preset structure arranged on the apparatus. The measurement value includes a point cloud or can be relative position information such as the distance or the azimuth angle.

Based on an optional embodiment of this disclosure, as described in FIG. 7, in step S1014, it is determined whether the measurement value is reasonable. When the measurement value is reasonable, the process proceeds to step S1013 and the measurement value can be stored as first reference data. When the measurement value is not reasonable, step S1012 is re-performed. As previously described, when the LiDAR is in the standard position and orientation, the point cloud determined based on the reference plane has a specific shape and a specific value. When the measurement value does not match the specific shape or the specific value in a theoretical situation, the measurement value is not reasonable, and it can be discarded and then the measurement can be re-performed. When the calibration object is a preset structure, the distance and the orientation of the LiDAR to the preset structure also have values with reasonable ranges. The measurement values can be determined to be unreasonable when they are out of the ranges. The first reference data is the standard data on which the diagnosis of the current position and orientation of the LiDAR is based, in such a case, accurate data needs to be determined. The performing of the reasonableness determination method can improve the accuracy of the first reference data to ensure the accuracy of the diagnostic result of the current position and orientation of the LiDAR.

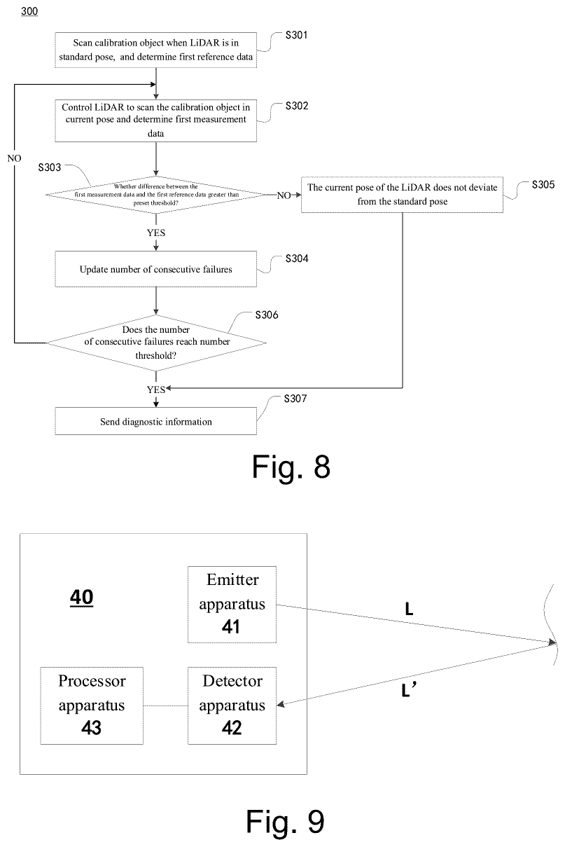

FIG. 8 shows a flow of an example diagnostic method 300 for the position and orientation of a LiDAR, consistent with an optional embodiment of this disclosure, which includes a process for determining whether there is a misdiagnosis in the diagnostic result. It is described in detail below in connection with FIG. 8.

Steps S301, S302, S303 and S305 in the diagnostic method 300 are substantially the same as steps S201, S202, S203 and S205 in the diagnostic method 200, with a difference being that the calibration object in this embodiment also includes a preset structure, and the above steps are not repeated here.

In step S304, when the difference between the first measurement data and the first datum data is greater than a predetermined threshold, instead of directly determining that the current position and orientation of the LiDAR deviates from the standard position and orientation, the number of consecutive failures can be updated. The initial value of the number of consecutive failures may be set to zero, and the number of consecutive failures can be counted when the difference between the first measurement data and the first datum data is greater than the preset threshold. The number of consecutive failures can be accumulated when the difference between the first measurement data and the first datum data is greater than the preset threshold the next time.

In optional embodiments, in step S303, the number of consecutive failures can be reset (e.g., cleared to zero) upon determining that the difference between the first measurement data and the first datum data does not exceed the preset threshold.

In step S306, it is determined whether the number of failures reaches a number threshold. When the number of failures does not each the number threshold, step S302 can be repeated to perform the scanning again in the current position and orientation of the LiDAR. When the number of consecutive failures reaches the number threshold, it is considered that the current position and orientation of the LiDAR deviates from the standard position and orientation. In step S307, diagnostic information can be sent, in such a case, the diagnostic information can be that the current position and orientation of the LiDAR deviates from the standard position and orientation. When it is determined in step S303 that the difference between the first measurement data and the first datum data is not greater than the preset threshold, it is determined that the current position and orientation of the LiDAR does not deviate from the standard position and orientation, and diagnostic information can also be sent. In such a case, the diagnostic information can be that the current position and orientation of the LiDAR does not deviate from the standard position and orientation.

When the current position and orientation of the LiDAR deviates from the standard position and orientation, the difference between the first measurement data and the first datum data is typically greater than the preset threshold. In such a case, when a situation occurs in which the difference between the first measurement data and the first datum data is not greater than the preset threshold in any diagnostic cycle, it can be considered that the current position and orientation of the LiDAR does not deviate, and the number of consecutive failures can be cleared to zero. When the difference between the first measurement data and the first datum data is greater than the preset threshold, there can be a misdiagnosis. In such a case, the number of consecutive failures can be incremented, and the diagnostic information can be sent when the number of consecutive failures reaches the number threshold. The setting of the number of consecutive failures can improve the accuracy of the process of diagnosis of the position and orientation of the LiDAR and exclude misdiagnosis, which can improve the accuracy of the diagnostic results. The threshold for the number of consecutive failures can be flexibly selected based on the specific using environment and the precision requirements of LiDAR.

Based on an optional embodiment of this disclosure, multiple LiDAR can be arranged at different positions of the apparatus. And current position and orientations of all the multiple LiDAR can be diagnosed using the aforementioned diagnostic method. When multiple LiDAR deviate from the standard position and orientations, it is confirmed whether a position and orientation (e.g., an altitude) of the apparatus deviates from a calibration position and orientation, the calibration position and orientation being a position and orientation of the apparatus when the step S101 is performed. In practical applications, the situation in which the multiple LiDAR deviate from the standard position and orientations is rare, and the first measurement data results can also be affected by the position and orientation of the apparatus. When the LiDAR scans the calibration object in the standard position and orientation, the apparatus is in the calibration attitude. When the situation occurs in which the multiple LiDAR deviate from the standard position and orientations, it is determined whether the attitude of the apparatus deviates from the calibration attitude.

As shown in FIG. 9, embodiments of this disclosure further relate to a LiDAR 40. The LiDAR 40 includes an emitter apparatus 41, a detector apparatus 42, and a processor apparatus 43. The emitter apparatus 41 can emit a detection signal L to the surrounding environment. The detector apparatus 42 can receive an echo L′ for the detection signal L. Further, the emitter apparatus 41 includes multiple channels for detection in multiple directions. The detector apparatus also includes corresponding channels to receive corresponding echoes. The processor apparatus 43 of the LiDAR can generate a point cloud of the LiDAR based on the echoes and perform the diagnostic method in the aforementioned embodiments to diagnose the current position and orientation of the LiDAR.

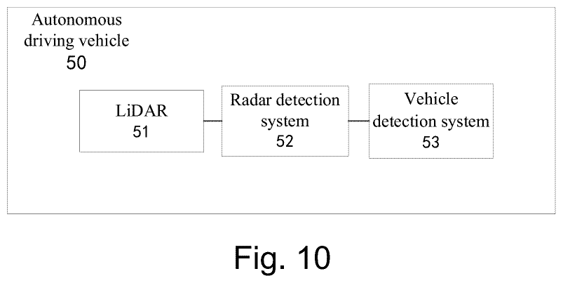

As shown in FIG. 10, embodiments of this disclosure further include an autonomous driving vehicle 50. The autonomous driving vehicle 50 includes one or more LiDAR 51 and a radar detection system 52. For example, one LiDAR 51 can be arranged on the roof of the autonomous driving vehicle 50, or multiple LiDAR 51 can be arranged on both sides of the front end and on the rear end of the autonomous driving vehicle 50. The radar detection system 52 can communicate with the LiDAR 51 and perform the diagnostic method in the aforementioned embodiments to diagnose whether the LiDAR 51 deviates from the standard position and orientation. Based on an optional embodiment of this disclosure, the autonomous driving vehicle 50 further includes a vehicle detection system 5. The vehicle detection system 53 can communicate with the radar detection system 52 and detect the position and orientation of the autonomous driving vehicle 50. When all LiDAR 51 on the autonomous driving vehicle 50 are diagnosed as deviating from the standard position and orientations, the vehicle detection system 53 can detect the position and orientation of the autonomous driving vehicle 50 to determine whether the position and orientation of the LiDAR is misdiagnosed due to the attitude of the autonomous driving vehicle 50. For example, the vehicle detection system 53 can detect whether the tire pressure of the autonomous driving vehicle 50 is normal, whether the body is level, or the like.

Embodiments of this disclosure further include a computer-readable storage medium including a computer-executable command stored on the computer-readable storage medium. The executable command can perform the diagnostic method for the position and orientation of the LiDAR as described in the aforementioned embodiments when executed by a processor.

Finally, it should be noted that what is described above is only optional embodiments of this disclosure and is not intended to limit this disclosure, and although this disclosure is described in detail with reference to the foregoing embodiments, for those skilled in the art, it is still possible for them to modify the technical solution recorded in the foregoing embodiments or to make equivalent substitutions for some of the technical features therein. Any modification, equivalent replacement, improvement, or the like made within the spirit and principle of this disclosure should be encompassed within the scope of protection of this disclosure.

1. A method for diagnosing a position and orientation of a LiDAR, the method comprising:
determining first reference data of a calibration object scanned by the LiDAR when the LiDAR is in a standard position and orientation;
controlling the LiDAR to scan the calibration object in a current position and orientation and to collect first measurement data of the LiDAR; and
determining, based on the first reference data and the first measurement data, whether the current position and orientation of the LiDAR deviates from the standard position and orientation.

2. The method of claim 1, wherein the step of determining, based on the first reference data and the first measurement data, whether the current position and orientation of the LiDAR deviates from the standard position and orientation comprises:
determining that the current position and orientation of the LiDAR deviates from the standard position and orientation when a difference between the first reference data and the first measurement data is greater than a predetermined threshold.

3. The method of claim 1, wherein the calibration object is a reference plane, the first reference data comprises a reference point cloud determined by scanning the reference plane by the LiDAR when the LiDAR is in the standard position and orientation, and the first measurement data comprises a measurement point cloud determined by scanning the reference plane by the LiDAR when the LiDAR is in the current position and orientation.

4. The method of claim 3, wherein a scanned parameter of the reference point cloud and/or the measurement point cloud comprises at least one of:
a shape of a point cloud;
a number of point cloud rings,
spacing between the point cloud rings,
a radius of a point cloud rings, or
a distance corresponding to a data point in the point cloud.

5. The method of claim 3, further comprising:
determining, based on the first measurement data, whether an apparatus is on a plane parallel to the reference plane, wherein the LiDAR is fixed to the apparatus; and
based on a determination that the apparatus is on the plane parallel to the reference plane, determining, based on the first reference data and the first measurement data, whether the current position and orientation of the LiDAR deviates from the standard position and orientation.

6. The method of claim 1, wherein the calibration object comprises a preset structure on an apparatus located within a scanning range of the LiDAR, wherein the LiDAR is fixed to the apparatus, the first reference data comprises at least one of a distance or an orientation determined by scanning the preset structure by the LiDAR when it the LiDAR is in the standard position and orientation, and the first measurement data comprises at least one of a distance or an orientation determined by scanning the preset structure by the LiDAR when the LiDAR is in the current position and orientation.

7. The method of claim 6, wherein the preset structure comprises a fixed structure or another LiDAR on the apparatus.

8. The method of claim 1, wherein the position and orientation comprises at least one of a mounting height or a mounting angle.

9. The method of claim 8, wherein the step of determining, based on the first reference data and the first measurement data, whether the current position and orientation of the LiDAR deviates from the standard position and orientation comprises:
determining, when the current position and orientation of the LiDAR deviates from the standard position and orientation, a deviation direction of the current position and orientation relative to the standard position and orientation.

10. The method of claim 1, wherein the step of determining the first reference data of the calibration object scanned by the LiDAR when the LiDAR is in the standard position and orientation comprises:
arranging the LiDAR in the standard position and orientation;
controlling the LiDAR to scan the calibration object to determine a measurement value of the LiDAR; and
storing the measurement value as the first reference data.

11. The method of claim 10, wherein the step of determining the first reference data of the calibration object scanned by the LiDAR when the LiDAR is in the standard position and orientation comprises:
determining whether the measurement value is within a range; and
based on a determination that the measurement value is not within the range, controlling the LiDAR to scan the calibration object in the current position and orientation to collect the first measurement data of the LiDAR.

12. The method of claim 1, wherein the step of determining, based on the first reference data and the first measurement data, whether the current position and orientation of the LiDAR deviates from the standard position and orientation comprises:
based on a determination that the current position and orientation of the LiDAR deviates from the standard position and orientation, incrementing a number of consecutive failures; and
determining whether the number of consecutive failures reaches a threshold, and sending a diagnostic data when the number of consecutive failures reaches the threshold.

13. The method of claim 1, wherein a plurality of LiDAR are arranged at different positions on an apparatus, wherein the LiDAR is fixed to the apparatus, and the method further comprises:
determining whether a position and orientation of the apparatus deviates from a calibration position and orientation when the plurality of LiDAR deviate from standard positions and orientations, wherein the calibration position and orientation is a position and orientation of the apparatus when determining the first reference data of the calibration object scanned by the LiDAR when the LiDAR is in the standard position and orientation.

14. The method of claim 1, wherein the LiDAR comprises a plurality of detection channels, and a part of the plurality of detection channels are used to perform the method.

15. A LiDAR, comprising:
an emitter configured to emit a detection signal to a surrounding environment;
a detector configured to receive an echo of the detection signal; and
a processor configured to generate a point cloud of the LiDAR based on the echo and configured to:
determine first reference data of a calibration object scanned by the LiDAR when the LiDAR is in a standard position and orientation;
control the LiDAR to scan the calibration object in a current position and orientation to collect first measurement data of the LiDAR; and
determine, based on the first reference data and the first measurement data, whether the current position and orientation of the LiDAR deviates from the standard position and orientation.

16. An autonomous driving vehicle, comprising:
a LiDAR fixed to the autonomous driving vehicle; and
LiDAR detection system in communication with the LiDAR and configured to:
determine first reference data of a calibration object scanned by the LiDAR when the LiDAR is in a standard position and orientation;
control the LiDAR to scan the calibration object in a current position and orientation to collect first measurement data of the LiDAR; and
determine, based on the first reference data and the first measurement data, whether the current position and orientation of the LiDAR deviates from the standard position and orientation.

17. The autonomous driving vehicle of claim 16, further comprising a vehicle detection system in communication with the LiDAR detection system and configured to:
detect a position and orientation of the autonomous driving vehicle.

18. The autonomous driving vehicle of claim 16, wherein the calibration object comprises a preset structure on the autonomous driving vehicle located within a scanning range of the LiDAR, the LiDAR is fixed to the autonomous driving vehicle, the first reference data comprises at least one of a distance or an orientation determined by scanning the preset structure by the LiDAR when the LiDAR is in the standard position and orientation, and the first measurement data comprises at least one of a distance or an orientation determined by scanning the preset structure by the LiDAR when the LiDAR is in the current position and orientation.

19. The method of claim 1, wherein determining, based on the first reference data and the first measurement data, whether the current position and orientation of the LiDAR deviates from the standard position and orientation comprises:
based on a determination that the current position and orientation of the LiDAR does not deviate from the standard position and orientation, setting a number of consecutive failures to zero.

20. The autonomous driving vehicle of claim 16, wherein a plurality of LiDAR are arranged at different positions on the autonomous driving vehicle, the LiDAR is fixed to the autonomous driving vehicle, and the LiDAR detection system configured to:
determining whether a position and orientation of the autonomous driving vehicle deviates from a calibration position and orientation when the plurality of LiDAR deviate from standard positions and orientations, wherein the calibration position and orientation is a position and orientation of the autonomous driving vehicle when determining the first reference data of the calibration object scanned by the LiDAR when the LiDAR is in the standard position and orientation.
